(19) United States
(12) Patent Application Publication
(10) Pub. No.: US 2026/0217226 A1
(43) Pub. Date: Jul. 30, 2026

(54) VEHICLE FRONT STRUCTURE

(71) Applicant: TOYOTA JIDOSHA KABUSHIKI KAISHA, Aichi-ken (JP)

(72) Inventor: Takayuki AMANUMA, Toyota-shi (JP)

(21) Appl. No.: 19/403,230

(22) Filed: Nov. 28, 2025

(30) Foreign Application Priority Data
Jan. 27, 2025 (JP) 2025-011435

(51) Int. Cl. B60T 5/00

(52) U.S. Cl. CPC B60T 5/00

(57) ABSTRACT

The vehicle front structure includes a front bumper, a duct, and a bracket. The front bumper is disposed on a front surface of the vehicle. The duct extends in a vehicle front-rear direction from front bumper. The bracket causes a skeletal member to support the duct. The skeletal member is spaced apart from the duct in an up-down direction. The bracket includes a skeleton-side fastening portion, a duct-side fastening portion, and an arm portion. The skeleton-side fastening portion is fastened to the skeletal member. The duct-side fastening portion is fastened to the duct. The arm portion connects the skeleton-side fastening portion and the duct-side fastening portion. The arm portion is disposed to be separated an in-vehicle component located behind the arm portion.

### CROSS REFERENCE TO RELATED APPLICATION

This application claims priority to Japanese Patent Application No. 2025-011435, filed on Jan. 27, 2025, which is incorporated herein by reference in its entirety including the specification, claims, drawings, and abstract.

### TECHNICAL FIELD

The present specification discloses a vehicle front structure.

### BACKGROUND

In JP2004-338602 A, a cooling duct structure is disclosed. In this structure, a duct is provided in the front portion of the vehicle. The duct extends from the front bumper at the front of the vehicle to the front wheel house.

In a low-load frontal collision such as a frontal collision at a low speed, the front bumper serves as a buffer. For example, when the front bumper is deformed (recessed), the impact is absorbed. However, if a duct extending in the front-rear direction of the vehicle is disposed in the front bumper, the duct may act as a strut at the time of a low-load frontal collision.

Therefore, in this specification, a vehicle front structure capable of ensuring a deformation amount of a front bumper in a low-load frontal collision is disclosed.

### SUMMARY

The present specification discloses a vehicle front structure. The vehicle front structure includes a front bumper, a duct, and a bracket. The front bumper is disposed on a front surface of the vehicle. The duct extends in a vehicle front-rear direction from front bumper. The bracket causes a skeletal member to support the duct. The skeletal member is spaced apart from the duct in an up-down direction. The bracket includes a skeleton-side fastening portion, a duct-side fastening portion, and an arm portion. The skeleton-side fastening portion is fastened to the skeletal member. The duct-side fastening portion is fastened to the duct. The arm portion connects the skeleton-side fastening portion and the duct-side fastening portion. The arm portion is disposed to be separated an in-vehicle component located behind the arm portion.

According to the above configuration, at the time of the low-load frontal collision, the arm portion is bent and deformed, so that the duct moves backward.

In addition, in the above configuration, an inner side in a vehicle width direction of an inlet opening of the duct may protrudes forward with respect to an outer side in the vehicle width direction of the inlet opening. In this case, the duct-side fastening portion includes an outer fastening portion and an inner fastening portion. The outer fastening portion is fastened to an outer side in the vehicle width direction of the duct. The inner fastening portion is fastened to an inner side in the vehicle width direction of the duct. The arm portion includes an outer arm portion and an inner arm portion. The outer arm portion connects the skeleton-side fastening portion and the outer fastening portion. The inner arm portion connects the skeleton-side fastening portion and the inner fastening portion. Further, the inner arm portion is longer than the outer arm portion.

According to the above configuration, the stroke of the inner portion of the duct in the vehicle width direction, which first hits the obstacle, at the time of retreating is ensured.

In addition, in the above configuration, the duct may include an enlarged diameter portion in front of the fastening portion to the duct-side fastening portion.

According to the above configuration, the bellows structure is formed in the duct in front of the duct-side fastening portion. At the time of a low-load collision, the enlarged diameter portion is crushed along the front-rear direction, so that the duct is restrained from protruding.

In the above configuration, a drain hole may be formed in the bottom surface of the enlarged diameter portion.

According to the above configuration, the water accumulated at the bottom of the enlarged diameter portion can be discharged.

According to the vehicle front structure disclosed herein, a deformation amount of the front bumper can be ensured in a low-load frontal collision.

### BRIEF DESCRIPTION OF DRAWINGS

Embodiments of the present disclosure will be described based on the following figures, wherein:

FIG. 1 is a side view illustrating a front portion of a vehicle;

FIG. 2 is a perspective view illustrating a structure around an inlet opening of a duct;

FIG. 3 is a plan view illustrating a structure around an inlet opening of a duct;

FIG. 4 is a front view illustrating a structure around an inlet opening of a duct;

FIG. 5 is a perspective view showing a state at the time of a low load collision;

FIG. 6 is a perspective view showing a first alternative example of the present embodiment; and

FIG. 7 is a perspective view showing a second alternative example of the present embodiment.

### DESCRIPTION OF EMBODIMENTS

Hereinafter, a vehicle front structure according to an embodiment will be described with reference to the drawings. The shapes, materials, numbers, and numerical values described below are for illustrative purposes only. These shapes and the like can be appropriately changed according to the specifications of the vehicle front structure. In the following description, the same reference numerals denote the same elements in all the drawings.

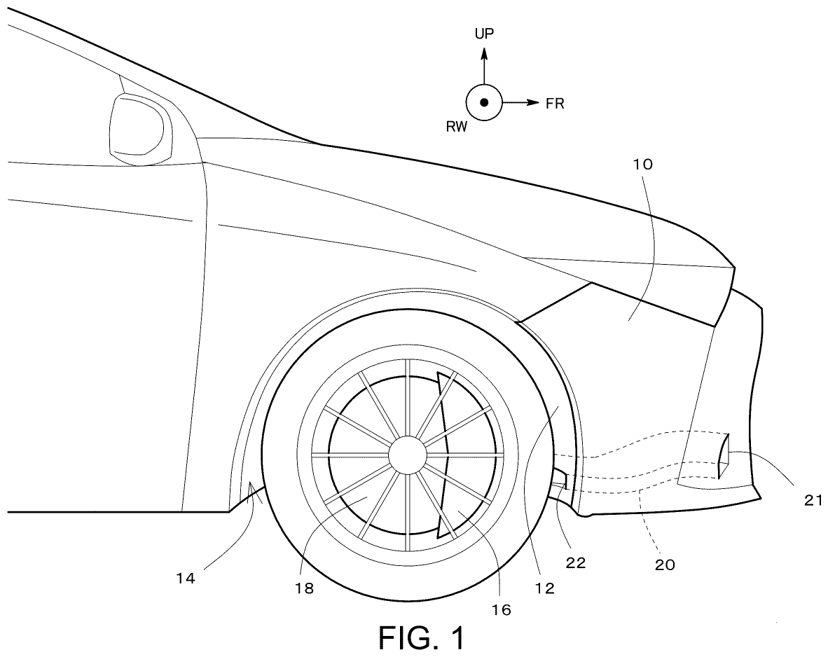

In FIGS. 1 to 7, an orthogonal coordinate system including an FR axis, an RW axis, and an UP axis is used to represent the position and direction of each configuration. The FR axis is a vehicle front-rear direction axis whose forward direction is the vehicle front side. The RW axis is a vehicle width direction axis whose forward direction is the right side of the vehicle. The UP axis is a vehicle vertical axis whose upward direction is a positive direction.

In FIGS. 1-7, only the structure on the right side of the vehicle is illustrated. However, based on the symmetry of the vehicle structure, a structure similar to that of FIGS. 1-7 is also provided on the left side of the vehicle.

### 1. An Outline of the Vehicle Front Structure

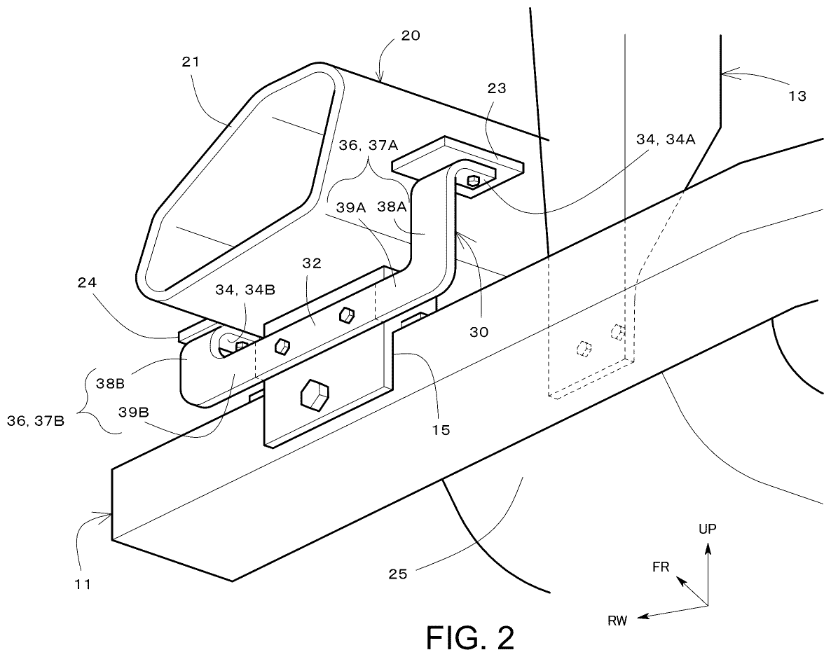

FIG. 1 illustrates a side view of a front portion of a vehicle. As described later, the vehicle front structure according to the present embodiment includes a front bumper 10, a duct 20, and a bracket 30 (see FIG. 2).

Referring to FIG. 1, a front bumper 10 is disposed on the front surface of the vehicle. The front bumper 10 is, for example, a resin component. The front bumper 10 extends in the vehicle width direction on the vehicle front surface. The front bumper 10 is a part of the design surface of the front surface of the vehicle. For example, the vehicle front surface is inclined toward the vehicle rear side from the center in the vehicle width direction toward both ends in the vehicle width direction. That is, the front bumper 10 has an arc shape in plan view.

A duct 20 is disposed in the front bumper 10. For example, the inlet opening 21 of the duct 20 is disposed in a lower region of the front bumper 10 and an outer region in the vehicle width direction. A mesh (not shown) for preventing inflow of pebbles or the like may be disposed in the inlet opening 21.

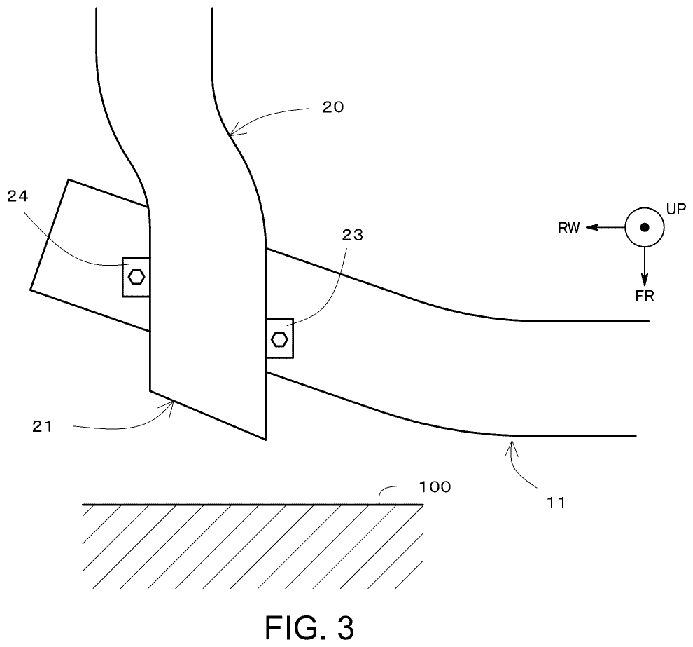

The duct 20 extends in the vehicle front-rear direction. Here, as illustrated in FIGS. 2 and 3, the duct 20 may extend so as to meander along the vehicle front-rear direction and the vehicle up-down direction. For example, FIG. 2 illustrates a bent portion 25 bent downward as a part of the duct 20.

The outlet opening 22 of the duct 20 is arranged in the wheel house 14. For example, the outlet opening 22 is disposed in the fender liner 12. The air taken into the duct from the vehicle front surface is sent into the wheel house 14 from the outlet opening 22. As a result, the brake caliper 16 and the disc rotor 18 are cooled.

### 2. Duct Fastening Structure

FIG. 2 illustrates the peripheral structure of the inlet opening 21 of the duct 20. The front bumper 10 is not shown. The duct 20 is supported at its forward portion by the framework member. The skeletal member is, for example, the lower bumper reinforcement 11. A front bumper 10 (see FIG. 1) is disposed in front of the lower bumper reinforcement 11.

The lower bumper reinforcement 11 extends in the vehicle width direction along the shape of the vehicle front surface. That is, as illustrated in FIG. 3, the lower bumper reinforcement 11 protrudes forward from the vehicle width direction inner side with respect to the vehicle width direction outer side. The lower bumper reinforcement 11 has an arc shape in a plan view.

Referring to FIG. 2, the lower bumper reinforcement 11 has, for example, a hollow rectangular shape in cross section. A connecting member 13 is fastened to the rear surface of the lower bumper reinforcement 11. The connecting member 13 is a reinforcing member having the same rigidity as that of the lower bumper reinforcement 11. The connecting member 13 extends upward from the lower bumper reinforcement 11. The upper end of the connecting member 13 is fastened to a front side member (not shown) which is a frame member.

The duct 20 is vertically separated from the lower bumper reinforcement 11. In FIG. 2, a duct 20 is disposed above the lower bumper reinforcement 11. As described later, the duct 20 is supported by the lower bumper reinforcement 11 via the bracket 30.

A reinforcement member 15 is disposed on the lower bumper reinforcement 11. For example, the reinforcement member 15 is fastened to the front surface and the upper surface of the lower bumper reinforcement 11. The reinforcement member 15 is a load transmission member at the time of a high load collision.

For example, when the lower bumper reinforcement of the oncoming vehicle is at a higher position than the lower bumper reinforcement 11, the reinforcement member 15 faces the lower bumper reinforcement of the oncoming vehicle. That is, the collision load is transmitted to the lower bumper reinforcement 11 via the reinforcement member 15.

Referring to FIGS. 2, 3, and 4, the inlet opening 21 of the duct 20 has a polygonal shape. An inlet opening 21 is formed along the shape of the lower bumper reinforcement 11. That is, with reference to FIG. 3, along the arc shape of the lower bumper reinforcement 11, the inlet opening 21 protrudes more forward than the vehicle width direction outer side on the vehicle width direction inner side.

The duct 20 includes a fastening portion to the bracket 30. That is, the duct 20 comprises an inner flange 23 and an outer flange 24. An inner flange 23 is disposed on an inner side wall of the duct 20 in the vehicle width direction. An outer flange 24 is disposed on an outer side wall of the duct 20 in the vehicle width direction.

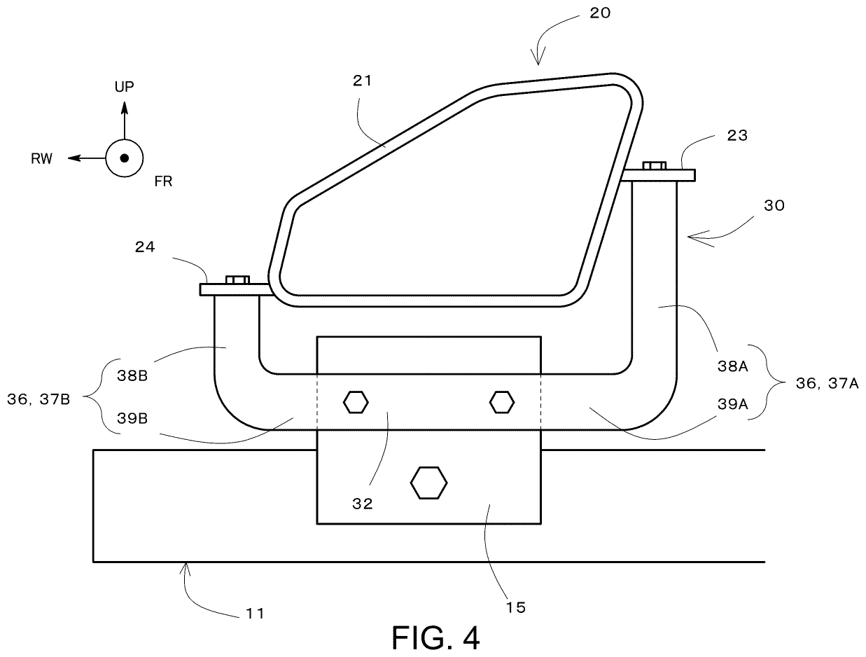

Referring to FIG. 3, the outer flange 24 is formed rearward of the inner flange 23 along the arc shape of the lower bumper reinforcement 11. Referring also to FIG. 4, the inner flange 23 is disposed at a higher position than the outer flange 24. With such an arrangement, at the time of a low-load frontal collision, the retraction stroke of the inner portion of the duct 20 in the vehicle width direction is secured.

### 3. Structure of Bracket

Referring to FIG. 2, bracket 30 supports duct 20 on lower bumper reinforcement 11. The bracket 30 is manufactured by, for example, pressing a metal plate piece. The bracket 30 includes a skeleton-side fastening portion 32, a duct-side fastening portion 34, and an arm portion 36.

The skeleton-side fastening portion 32 is fastened to the lower bumper reinforcement 11. In the example of FIG. 2, the skeleton-side fastening portion 32 is fastened to the lower bumper reinforcement 11 via the reinforcement member 15. That is, the skeleton-side fastening portion 32 is bolted to the front surface of the reinforcement member 15.

The duct-side fastening portion 34 is bolted to the duct 20. The duct-side fastening portion 34 includes an inner fastening portion 34A and an outer fastening portion 34B. The inner fastening portion 34A is fastened to the inner side of the duct 20 in the vehicle width direction. For example, the inner fastening portion 34A is bolted to the inner flange 23 of the duct 20. The outer fastening portion 34B is fastened to the outside of the duct 20 in the vehicle width direction. For example, the outer fastening portion 34B is bolted to the outer flange 24.

The arm portion 36 connects the skeleton-side fastening portion 32 and the duct-side fastening portion 34. The arm portion 36 is extended so as not to overlap the reinforcement member 15 along the vehicle front-rear direction, for example. In addition, the arm portion 36 is disposed so that the plate thickness direction is the vehicle front-rear direction. The arm portion 36 includes an inner arm portion 37A and an outer arm portion 37B.

The inner arm portion 37A connects the skeleton-side fastening portion 32 and the inner fastening portion 34A. The inner arm portion 37A includes a vertical arm 38A and a lateral arm 39A. The lateral arm 39A extends inward in the vehicle width direction from the skeleton-side fastening portion 32. The vertical arm 38A is connected to an inner end portion of the lateral arm 39A in the vehicle width direction. The vertical arm 38A extends in the vertical direction. The upper end of the vertical arm 38A is connected to the inner fastening portion 34A.

Similarly, the outer arm portion 37B connects the skeleton-side fastening portion 32 and the outer fastening portion 34B. The outer arm portion 37B includes a vertical arm 38B and a lateral arm 39B. The lateral arm 39A extends outward in the vehicle width direction from the skeleton-side fastening portion 32. The vertical arm 38B is connected to an outer end portion of the lateral arm 39B in the vehicle width direction. The vertical arm 38B extends in the vertical direction. The upper end of the vertical arm 38B is connected to the outer fastening portion 34B.

Here, the inner arm portion 37A is longer than the outer arm portion 37B. For example, the vertical arm 38A of the inner arm portion 37A is longer than the vertical arm 38B of the outer arm portion 37B. Thus, as will be described later, the stroke of the inner portion of the duct 20 in the vehicle width direction at the time of retreating is secured.

Referring to FIG. 2, a connecting member 13, which is an in-vehicle component, is disposed behind the inner arm portion 37A. Here, the inner arm portion 37A and the connecting member 13 are disposed apart from each other in the vehicle front-rear direction. That is, a gap is provided between the inner arm portion 37A and the connecting member 13. As will be described later, this gap serves as a collapse space of the inner arm portion 37A in a low-load frontal collision. An interval equal to or greater than the length of the vertical arm 38A is provided between the inner arm portion 37A and the connecting member 13, for example.

### 4. At the Time of Low Load State Collision

Referring to FIG. 3, at the time of a low load collision, obstacle 100 collides with the front surface of the vehicle. As described above, the inside of the duct 20 in the vehicle width direction protrudes more forward than the outside in the vehicle width direction. Therefore, the inner portion of the duct 20 in the vehicle width direction comes into contact with the obstacle 100 earlier than the outer portion in the vehicle width direction.

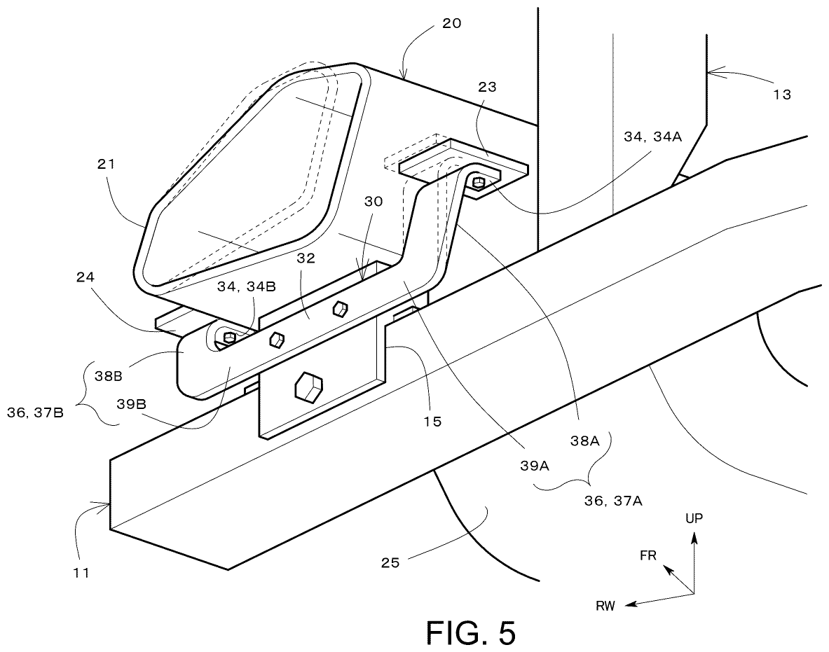

Referring to FIG. 5, when a collision load is input to the inner side in the vehicle width direction of duct 20, vertical arm 38A of inner arm portion 37A bends and deforms rearward. Here, as described above, the connecting member 13 is disposed apart from the inner arm portion 37A. Therefore, even when the vertical arm 38A is bent rearward, the connecting member 13 does not interfere with the vertical arm 38A.

Here, the inner arm portion 37A is formed to be longer than the outer arm portion 37B. This ensures a stroke for retracting the duct 20. For example, at the time of a low-load frontal collision, the duct 20 retreats so as to rotate about the vertical arm 38B of the outer arm portion 37B as a central axis. When the duct 20 retreats, the deformation amount of the front bumper 10 (see FIG. 1) is secured.

### 5. In the Present Embodiment, Another Example (a First Single Arm)

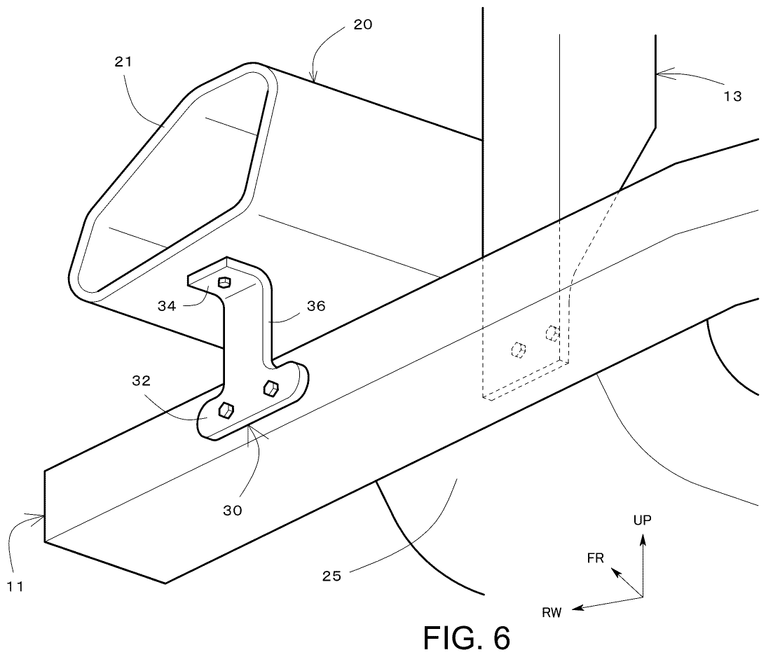

FIG. 6 shows a first alternative example of the vehicle front structure according to the present embodiment. In this example, a single arm bracket 30 is shown.

The bracket 30 includes a skeleton-side fastening portion 32, a duct-side fastening portion 34, and an arm portion 36. The skeleton-side fastening portion 32 is directly fastened to the lower bumper reinforcement 11. The reinforcement member 15 (see FIG. 2) is not provided at least in the vicinity of the bracket 30 of the lower bumper reinforcement 11.

The duct 20 is spaced above the lower bumper reinforcement 11. The bracket 30 supports the duct 20 on the lower bumper reinforcement 11. The arm portion 36 extends in the vertical direction from the skeleton-side fastening portion 32. The lower end of the arm portion 36 is connected to the skeleton-side fastening portion 32. The upper end of the arm portion 36 is fastened to the duct-side fastening portion 34. The duct-side fastening portion 34 is bolted to the bottom surface of the duct 20. For example, the duct-side fastening portion 34 is fastened to the center portion in the vehicle width direction of the bottom surface of the duct 20.

In the example of FIG. 6, the in-vehicle component disposed behind the arm portion 36 is the bent portion 25 of the duct 20. As shown in the figure, the arm portion 36 and the bent portion 25 are spaced apart from each other. Therefore, the space behind the arm portion 36 serves as a collapse space for the arm portion 36 to be bent backward.

### 6. In the Present Embodiment, Another Example (the Second Duct in Which a Diameter-Enlarged Portion)

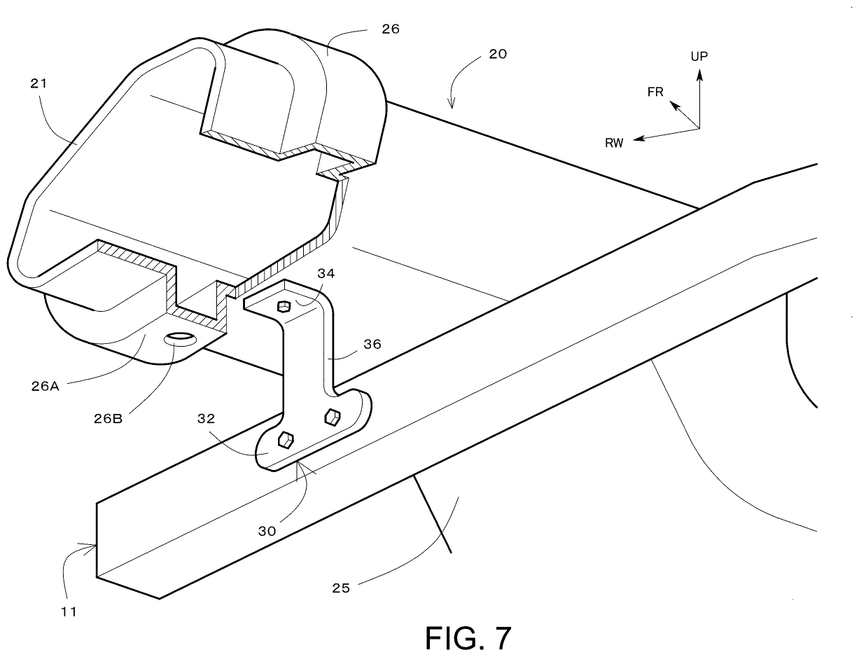

FIG. 7 shows a second variation of the vehicle front structure according to the present embodiment. In this example, the enlarged diameter portion 26 is formed in the duct 20.

In FIG. 7, the duct 20 is supported by a single-arm bracket 30. Alternatively, the duct 20 may be supported by a paired arm bracket 30 illustrated in FIG. 2.

The duct 20 is formed with an enlarged diameter portion 26 in front of the fastening portion to the duct-side fastening portion 34. The inner circumference of the enlarged diameter portion 26 is enlarged over the entire circumference as compared with the front and rear portions thereof. FIG. 7 shows a cross section of the enlarged diameter portion 26. In the periphery of the enlarged diameter portion 26, the cross section has a stepped structure.

Due to this stepped structure, a bellows structure is formed in the duct 20. That is, at the time of a low-load frontal collision, the enlarged diameter portion 26 is crushed. Thus, the deformation amount of the front bumper 10 is secured.

Since outside air flows into the duct 20, rainwater or the like may enter the duct 20. Therefore, a drain hole 26B may be drilled in the bottom surface 26A of the enlarged diameter portion 26. The water in the duct 20 that has flowed into the enlarged diameter portion 26 is discharged to the outside of the vehicle through the drain hole 26B.

The present disclosure is not limited to the present embodiments described above, and includes all changes and modifications without departing from the technical scope or the essence of the present disclosure defined by the claims.

1. A vehicle front structure comprising:
a front bumper disposed on a front face of the vehicle;
a duct extending in a vehicle front-rear direction from the front bumper;
a bracket causing a skeletal member spaced apart from the duct in an up-down direction to support the duct; wherein
the bracket comprises:
a skeleton-side fastening portion fastened to the skeletal member;
a duct-side fastening portion fastened to the duct;
an arm portion connecting the skeleton-side fastening portion and the duct-side fastening portion; and
the arm portion is disposed to be separated from an in-vehicle component located behind the arm portion.

2. The vehicle front structure according to claim 1, wherein
an inner side in a vehicle width direction of an inlet opening of the duct protrudes forward with respect to an outer side in the vehicle width direction of the inlet opening;
the duct-side fastening portion comprises:
an outer fastening portion fastened to an outer side in the vehicle width direction of the duct; and
an inner fastening portion fastened to an inner side in the vehicle width direction of the duct;
the arm portion comprises:
an outer arm portion connecting the skeleton-side fastening portion and the outer fastening portion; and
an inner arm portion connecting the skeleton-side fastening portion and the inner fastening portion; and
the inner arm portion is longer than the outer arm portion.

3. The vehicle front structure according to claim 1, wherein
the duct includes an enlarged diameter portion in front of a fastening portion to the duct-side fastening portion.

4. The vehicle front structure according to claim 3, wherein a drain hole is formed in a bottom surface of the enlarged diameter portion.
